(19) United States
(12) Patent Application Publication
(10) Pub. No.: US 2004/0188127 A1
(43) Pub. Date: Sep. 30, 2004

(54) Cover for an electronic device

(75) Inventors: Matthias Braun, Thundorf (DE); Michael Bzdziuch, Bad Konigshofen (DE); Hubertus Bahr, Bad Konigshofen (DE); Achim Demmer, Bad Kissingen (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 10/773,749

(22) Filed: Feb. 6, 2004

(30) Foreign Application Priority Data
Feb. 6, 2003 (DE) 103 04 905.3

(51) Int. Cl. H02G 3/14

(52) U.S. Cl. 174/66

(57) ABSTRACT

A hood-shaped cover for an electronic device includes a device-proximal bottom side and a device-distal side, and a cable guide for routing a connecting cable of the electronic device such that a plug-in connector of the connecting cable is connectable to the electronic device. The cable guide includes in the device-proximal bottom side an opening which is configured to extend helically toward the device-distal side into a passageway for encompassing the connecting cable and terminates in a cable outlet disposed tangentially to the device-distal side of the bottom.

### CROSS-REFERENCES TO RELATED APPLICATIONS

This application claims the priority of German Patent Application, Serial No. 103 04 905.3, filed Feb. 6, 2003, pursuant to 35 U.S.C. 119(a)-(d), the disclosure of which is incorporated herein by reference.

### BACKGROUND OF THE INVENTION

The present invention relates, in general, to a cover for an electronic device.

German Pat. No. DE 43 04 032 describes an angle measurement device as used in industrial plants and having a housing with a cutout which is covered by a hood. Although these types of electronic device have been used for many years, there is a problem that exposed wires of the cable can inadvertently be pinched, when the hood is improperly mounted. In particular in situations that involve live covers, there is a danger of major electric failure.

It would therefore be desirable and advantageous to provide an improved cover to obviate prior art shortcomings and to prevent inadvertent damage to cable wires.

### SUMMARY OF THE INVENTION

According to one aspect of the present invention, a hood-shaped cover for an electronic device includes a device-proximal bottom side and a device-distal side, and a cable guide for routing a connecting cable of the electronic device such that a plug-in connector of the connecting cable is connectable to the electronic device, wherein the cable guide includes in the device-proximal bottom side an opening which is configured to extend helically toward the device-distal side into a passageway for encompassing the connecting cable and terminates in a cable outlet disposed tangentially to the device-distal side of the bottom. In this way, care is taken that the cable cannot be inadmissibly bent too tightly or kinked.

According to another feature of the present invention, a lid closure is provided for covering the cable guide. Thus, the cover can be placed first on the electronic device before the cable is routed and the lid closure is attached to completely seal off the cover.

According to another feature of the invention, the cable outlet can be constructed so as to be tight and strain relieved. As a result, a required tightness and reliability are realized, when used for industrial equipments. Suitably, the lid closure may be constructed hereby as clamp element to provide strain relief for the cable. The need for additional clamp elements, as disclosed e.g. in European patent publication EP 0 776 065 A1, can now be entirely eliminated.

According to another feature of the invention, the cover may include a shield which extends above the opening. Suitably, the shield has an attachment member for connection of the shield to the bottom of the cover and has a recessed end surface in proximity of the cable outlet to define said passageway.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic perspective view of an exemplary open-topped electronic device;

FIG. 2 is a side elevation of a connecting cable for the electronic device;

FIG. 3 is a top and side perspective view of a cover according to the present invention for closing the electronic device; and

FIG. 4 is a top and side perspective view of a lid closure for attachment to the cover of FIG. 3.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

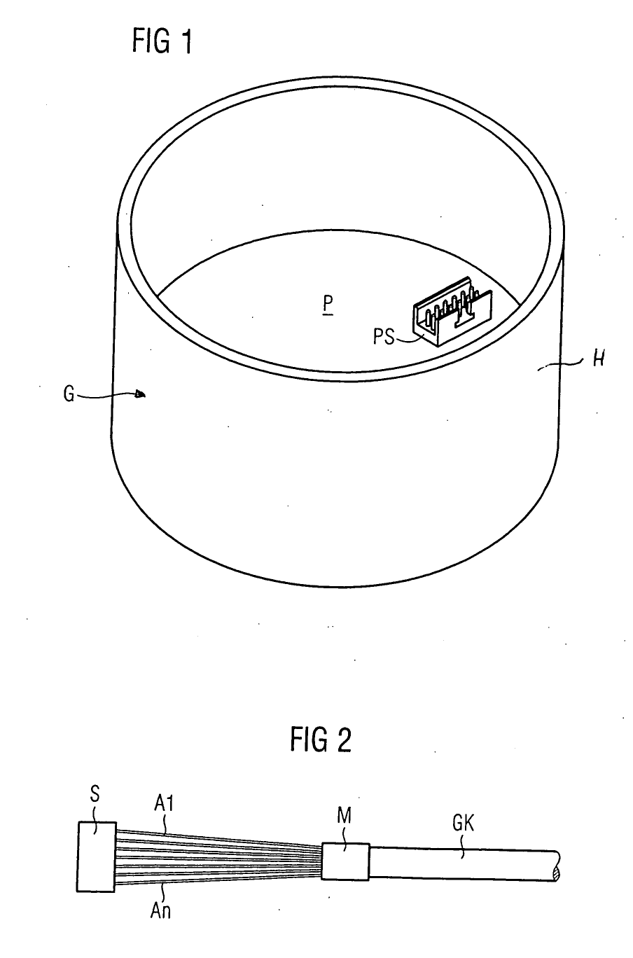

Turning now to the drawing, and in particular to FIG. 1, there is shown a schematic perspective view of an exemplary open-topped electronic device, which is generally designated by reference character G and which may, for example, represent an angle position transducer. The electronic device G has a cylindrical housing H which accommodates a circuit board P for mounting electronic and mechanical components. For the sake of simplicity, FIG. 1 shows only the provision of a socket PS on the circuit board P, when in fact other electronic and mechanical components are mounted thereon as well. However, these components are not part of the invention, and thus have been omitted.

An electrical connection between the electronic device G and the remainder of an electronic system is made by a flexible electrical connecting cable GK, as shown in FIG. 2. The connecting cable GK terminates in a plug-in connector S for insertion into the socket PS and is suitably stripped in proximity of the plug-in connector S. Thus, the single wires A1 . . . An are individually exposed. A metal sleeve M is secured in force-fitting and/or form-fitting manner to the cable GK in the area of the stripped zone of the cable GK.

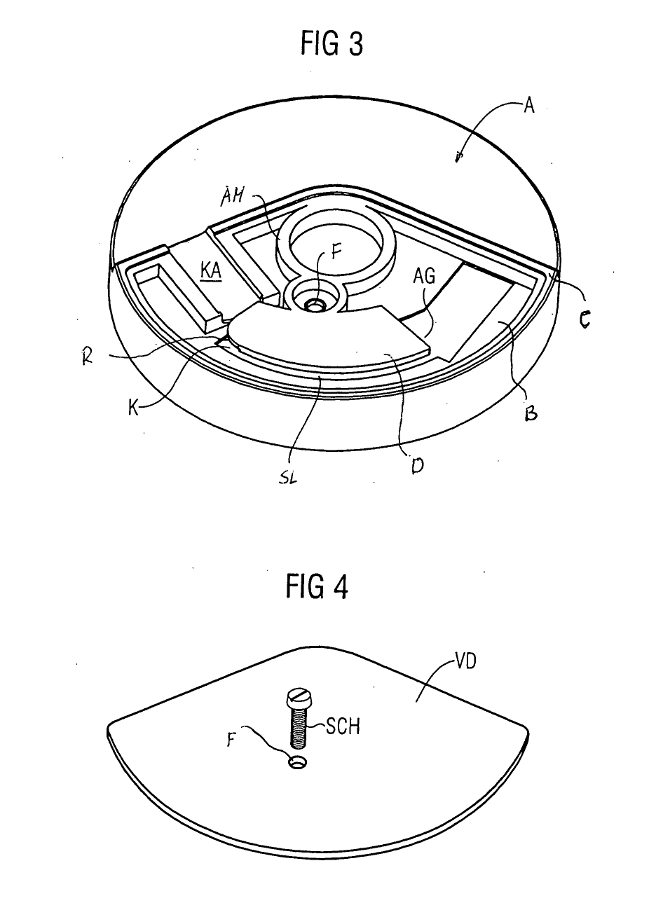

Referring now to FIG. 3, there is shown a top and side perspective view of a cover according to the present invention, generally designated by reference character A, for tightly sealing the open top of the electronic device G. The cover A is hereby placed over the electronic device G to seal it from the outside, while allowing a passage of the cable GK.

The cover A has a hood-shaped or dome-shaped configuration and is formed with a cutout C to expose a cable guide of the cover A for routing the connecting cable GK. The cutout C has a bottom B and defines a device-proximal area and a device-distal area. Formed in the device-proximal area in the bottom B at a location above the socket PS is an opening AG to allow access thereto. The opening AG is configured to match the configuration of the connecting cable GK in the area of the cable guide and is extended by a curved finger-like slot SL. Thus, the opening AG including the slot SL define a helical-like configuration toward the device-distal area of the cutout C to terminate in a cable outlet tray KA of the cover A.

The cover A is further provided with a shield D which forms an essential part of the cable guide and extends essentially above the slot SL of the opening AG. The shield D is connected to the bottom B of the cover A via an attachment member AM which extends adjacent to the slot SL in the direction of mid-section of the cover A. Suitably, the shield D has a recessed end surface R adjacent to the cable outlet KA to define a passageway K for receiving and guiding the wires A1 . . . An of the cable GK. Thus, the cable guide extends in a helical manner from the opening AG at the lower device-proximal area of the cutout C via the curved slot SL, passageway K to the cable outlet tray KA at the higher device-distal area of the cutout C.

Installation of the connecting cable GK is as follows: Initially, the cover A is placed over the open top of the housing H of the electronic device G. The plug-in connector S is then attached to the socket PS, whereby the wires A1 . . . An are positioned in the passageway K and the metal sleeve M is placed into the cable outlet tray KA. Subsequently, a lid closure VD, as shown in FIG. 4, is attached to the cover A over the cutout C to securely and tightly close the cover A and shield the cable GK in such a way that the metal sleeve M in the outlet tray KA is clamped sufficiently to ensure a secure position of the connecting cable GK. Suitably, the lid closure VD is hereby mechanically connected to the cover A by at least one screw SCH which is threadably engageable in aligned bores F in the lid closure VD and cover A. In this way, the lid closure VD provides a strain relief for the connecting cable GK.

Although not shown in detail, it is, of course, also possible to construct the cover A as integral part of the electronic device G.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A hood-shaped cover for an electronic device, comprising a device-proximal bottom side and a device-distal side, and a cable guide for routing a connecting cable of the electronic device such that a plug-in connector of the connecting cable is connectable to the electronic device, said cable guide including in the device-proximal bottom side an opening which is configured to extend helically toward the device-distal side into a passageway for encompassing the connecting cable and terminates in a cable outlet disposed tangentially to the device-distal side.

2. The cover of claim 1, and further comprising a lid closure for covering the cable guide.

3. The cover of claim 1, wherein the cable outlet is constructed so as to be tight and strain-relieved.

4. The cover of claim 2, wherein the lid closure is constructed as clamp element for strain relief.

5. The cover of claim 2, wherein the lid closure and the cover have aligned bores for threaded engagement of a screw.

6. The cover of claim 1, wherein the cover includes a shield which extends above the opening.

7. The cover of claim 6, wherein the shield has an attachment member for connection of the shield to the bottom of the cover.

8. The cover of claim 6, wherein the shield has a recessed end surface in proximity of the cable outlet to define said passageway.

9. The cover of claim 1, wherein the cable outlet is constructed in the form of a tray.

10. In combination with an open-topped electronic device, a cover for securely shielding the electronic device, and a flexible electrical cable secured to the electronic device and the cover, said cover including a hood-shaped cover portion constructed for attachment over the top of the electronic device and formed with a cutout having a device-proximal bottom area and a device-distal upper area, and a cable guide disposed in the area of the cutout, said cable guide including an opening disposed in the device-proximal bottom area and extended by a curved slot for passage of the cable, and a cable outlet disposed in the device-distal area in proximity of the slot.

11. The combination of claim 10, wherein the cover includes a lid closure for closing the cutout.

12. The combination of claim 11, wherein the lid closure is constructed as clamp element for strain relief.

13. The combination of claim 11, wherein the lid closure and the cover portion have aligned bores for threaded engagement of a screw.

14. The combination of claim 10, wherein the cover includes a shield which extends substantially above the slot of the opening.

15. The combination of claim 14, wherein the shield has an attachment member for connection of the shield to a bottom of the cutout.

16. The combination of claim 14, wherein the shield has a recessed end surface in proximity of the cable outlet to define a passageway for passage of the cable.

17. The combination of claim 10, wherein the cable outlet is constructed in the form of a tray.
